(19) United States
(12) Patent Application Publication
(10) Pub. No.: US 2007/0081683 A1
(43) Pub. Date: Apr. 12, 2007

(54) Physiologically-Based Signal Processing System and Method

(75) Inventor: Laurel H. Carney, Syracuse, NY (US)

Correspondence Address: BOND, SCHOENECK & KING, PLLC, ONE LINCOLN CENTER, SYRACUSE, NY, 13202-1355, US

(73) Assignee: SYRACUSE UNIVERSITY, Syracuse, NY (US)

(21) Appl. No.: 11/539,660

(22) Filed: Oct. 9, 2006

Related U.S. Application Data
(60) Provisional application No. 60/596,656, filed on Oct. 11, 2005.

(51) Int. Cl. H04R 25/00

(52) U.S. Cl. 381/321; 381/312

(57) ABSTRACT

A system and method for improving sound quality for subjects with impaired hearing by applying a lowpass filter and a set of mid- to high-frequency narrowband filters to a signal. A set of narrowband filters are applied to sounds so that the impaired ear is stimulated to respond in a manner more similar to that of a healthy ear at low to moderate sound levels, for which intelligibility is high. Information falling outside of the set of narrowband filters is “discarded” or filtered out, which preserves the representation of the information in the narrowbands. Because energy at frequencies between the narrowband filters is discarded, the sound spectrum is significantly changed, resulting in a clearer sound that is more natural and higher in intelligibility than conventional sounds or sound processing techniques.

### CROSS-REFERENCE TO RELATED APPLICATIONS

This application claims priority to U.S. Provisional Patent Application Ser. No. 60/596,656, filed Oct. 11, 2005.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. R21 DC006057 awarded by the National Institutes of Health, National Institute on Deafness and Other Communication Disorders.

### BACKGROUND OF THE INVENTION

1. Field of the Invention

The present invention relates to signal processing used in hearing aids and cochlear implants and, more specifically, to techniques for enhancing the quality and intelligibility of sounds, particularly in situations involving loud sounds or noise, or for listeners with hearing loss.

2. Description of the Related Art

Conventional aids for assisting hearing impaired users involve the use of analog or digital circuits for selective amplification or gain processing for increased audibility of sounds of interest without discomfort resulting from high intensity sounds. Hearing aids may also use expansion techniques to lead to greater listener satisfaction by reducing the intensity of low-level environmental sounds and microphone noise that otherwise may have been annoying to the user. Digital signal process techniques may also be used to provide feedback reduction schemes through the use of a cancellation system or notch filtering and to provide digital noise reduction to reduce gain in low frequencies or in specific bands when noise is detected. These systems are not based on the physiological causes of hearing loss and are therefore not always effective.

Other attempts to correct for hearing loss causing a reduction in frequency resolving capacity of the ear involve splitting the input speech signal into two signals by using a bank of critical band filters where odd numbered critical bands are presented to one ear and even numbered ones to the other. Unfortunately, this process only results in marginal improvement in intelligibility. Other attempts to correct for hearing loss involve filtering sound into a few discrete bands. While this process is helpful for identifying the frequency ranges that are more important in sound recognition and intelligibility, it does not actually improve intelligibility when used as a corrective implementation.

### SUMMARY OF THE INVENTION

It is therefore a principal object and advantage of the present invention to provide a physiologically based system and method that provides higher quality sounds.

It is an additional object and advantage of the present invention to provide a physiologically based system and method that provides natural sounding signals.

It is a further object and advantage of the present invention to provide a physiologically based system and method for improving the intelligibility of sounds.

In accordance with the foregoing objects and advantages, the present invention provides a system and method for processing sounds by applying a lowpass filter and a set of mid- to high-frequency narrowband filters to a signal. Frequency filtering in the impaired ear, or in the healthy ear at high sound levels, is less selective than in the healthy ear at low sound levels. By applying a set of carefully chosen narrowband filters to the sound, an impaired ear is stimulated to respond in a manner more similar to that of a healthy ear at low to moderate sound levels, for which intelligibility is high. Information that falls outside of the set of narrowband filters is “discarded” or filtered out, which preserves the representation of the information in the narrowbands. The signal processing results in a significant change in the sound spectrum. Because energy at frequencies between the narrowband filters is essentially “discarded”, the processed signal has a “sparse” spectrum, resulting in a clearer sound that is more “natural” and higher in “quality” in subjects with hearing loss than conventional signals.

### BRIEF DESCRIPTION OF THE DRAWINGS

The present invention will be more fully understood and appreciated by reading the following Detailed Description in conjunction with the accompanying drawings, in which:

FIG. 1 is a schematic diagram of the signal-processing strategy of the present invention.

### DETAILED DESCRIPTION

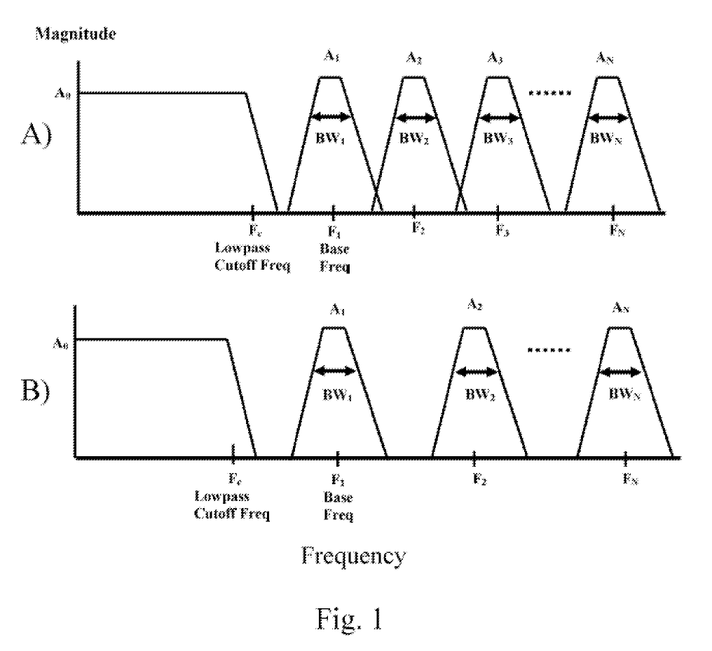

Referring now to the drawings, wherein like reference numerals refer to like parts throughout, there is seen in FIG. 1 a frequency response according to the linear signal-processing strategy of the present invention for improving hearing of a subject, such as a hearing impaired individual. Response (A) of FIG. 1 illustrates a system with a relatively low “sparseness” or spacing between the narrowband filters and relatively small spacing between lowpass filter and lowest frequency narrowband filter. Response (B) of FIG. 1 illustrates a system with higher “sparseness.” The process of the present invention thus comprises the steps of simultaneously applying a lowpass filter and a set of mid- to high-frequency narrowband filters to a signal so that only low frequencies and spaced apart bands of higher frequencies are presented to an individual.

At low sound levels, a healthy inner ear can be characterized as a bank of sharply tuned narrowband filters. An impaired ear, however, may be characterized as a bank of broader, and thus more highly overlapping, filters. In response to high sound levels, a healthy ear is also characterized by broader filters since the bandwidth of tuning in the healthy ear varies with sound level. Responses of broad filters to complex sounds are substantially different from responses of narrow, sharply tuned filters to the same sounds. However, it is possible to force a broad filter to respond as though it were a more sharply tuned filter by pre-filtering the signal with a sharply tuned filter and then “protecting” the narrow band by eliminating energy from neighboring bands.

The signal-processor of the present invention provides a sparse, punctuated spectrum at frequencies greater than approximately 1500 Hz. It should be recognized by those of skill in the art that this frequency may be adjusted for each listener or for particular situations. By presenting narrow frequency bands of energy, rather than the complete sound spectrum, the responses of broad frequency filters in the inner ear of listeners with hearing loss, or of normal-hearing listeners at high sound levels, will more closely resemble the responses of the sharply-tuned filters in the healthy ear (at low to moderate sound levels, for which intelligibility is highest). Also, because the signal-to-noise ratio in the narrowbands of energy are more similar to those in the responses of the sharply tuned filters in the healthy ear, the ability of the auditory system to detect and identify signals in the presence of noise should be improved by this signal-processing strategy.

Several parameters can be adjusted to customize the system for a particular listener or situation. For example, the most important parameter of the system is the “sparseness” of the narrowband filters, which can be adjusted (increased sparseness refers to increased spacing between the center frequencies of the narrowband filters, F1 . . . FN). Referring to FIG. 1, the sparseness parameter is illustrated not only in the separations in frequency between the center frequencies of the narrowband filters, but also between the cutoff frequency of the lowpass filter (Fc) and the center frequency of the lowest frequency narrowband filter (F1). In general, for listeners with greater hearing loss (and thus broader frequency tuning in the inner ear), a sparser set of filters is appropriate in order to compensate for this broad tuning. The sparse set of filters prevents neighboring frequency bands from passing through the same filter in the inner ear. When multiple frequency bands pass through broad filters, the resulting response is strongly affected by interactions across different frequencies. By “protecting” each narrow band of energy (i.e., by “discarding” the energy in the source that is just lower or higher in frequency with respect to each narrowband filter), these interactions can be reduced. For normal-hearing listeners, greater sparseness values would benefit sound quality and intelligibility for higher sound levels or higher background noise levels.

The strategy for determining the spacing of the narrowband filters is flexible. A simple strategy is to space the filters evenly on an equivalent-rectangular bandwidth frequency scale (an approximately logarithmic scale), based on our knowledge of the frequency tuning properties of the inner ear. Other strategies (within reason) for placing the narrowband filters along the frequency axis are also acceptable and result in high quality signals.

Another parameter that can be adjusted to customize the system for a particular listener or situation is the number of narrowband filters (N), which together with the sparseness determines the total frequency range of the system. This parameter can be adjusted based on a listener's hearing abilities.

The frequency shapes of the narrowband filters can also be adjusted. Filters that introduce as little phase distortion as possible will perform best, e.g., rectangular finite-impulse-response (FIR) filters perform well.

The gain of the lowpass filter (A₀) and the gains of each narrowband filter (A₁ . . . A_{N}) can each be adjusted independently. In the case of listeners with hearing loss, these gains can be adjusted to compensate for different amounts of hearing loss at different frequencies, i.e., frequency shaping. For normal-hearing listeners, the gains of the narrowband filters can be kept uniform across frequency (as illustrated in FIG. 1), or adjusted independently, based on comfort or personal preference. The relative gain of the lowpass filter and the narrowband filters can also be adjusted.

The base frequency (i.e., the center frequency of the lowest frequency narrowband filter, F₁) may also be adjusted to determine the transition frequency between the lowpass filter and the narrowband filtering. The base frequency can be adjusted for a given listener or situation. For example, when listening to running speech, the base frequency might be set to approximately 1800 Hz, which is in the middle of the range of second-formant frequencies for running speech sounds. Such a setting guarantees that this important frequency region is preserved, and that it is protected from undesired interactions with immediately neighboring frequencies. For other listening material (e.g., music), other base frequencies might be preferred by listeners.

The bandwidths of the narrowband filters (BW₁. . . BW_{N}) may also be adjusted. For example, the equivalent rectangular bandwidths (ERBs) estimated for human hearing as a function of frequency work well. Narrower frequency tuning for the narrowband filters may improve sound quality in certain situations, but if the filters become too narrow, the sound spectrum could become too impoverished.

Nearly all listeners with hearing loss who have been tested prefer, based on quality, some degree of “sparseness” as compared to unprocessed, wide spectrum spounds. The processed sound is described as being more natural, higher in quality, and comfortable to the listener. At least one subject with hearing loss showed large improvements in preliminary objective intelligibility tests using key words in a set of sentences, while others showed smaller improvements or insignificant changes in intelligibility. The quality and intelligibility of “sparse” sounds are excellent for normal-hearing listeners, which is counter-intuitive since much of the sound spectrum is discarded by the processing.

The processing strategy of the present invention illustrated in FIG. 1 is a linear filter, which results in a filter that is straightforward to implement and that introduces very little unwanted distortion in the sound. However, this strategy could be combined with existing nonlinear signal-processing strategies, for example, systems that introduce compression for listeners with hearing loss. Alternatively, the responses of the narrowband filters could be modified using expansive nonlinearities in order to enhance certain aspects of the responses of high-frequency auditory neurons. These modifications would introduce distortion, but might provide benefits in certain situations or for certain listeners.

The signal-processing strategy of the present invention may be implemented in software, such as by using the MatLab programming environment. Standard linear digital filters may be used to implement the low-pass and bandpass filters. The signal-processing strategy of the present invention may also be implemented a DSP chip that allows real-time processing. The chip may be programmed using assembly language and controlled through a personal computer interface.

It should be obvious to those of skill in the art that the present invention may be implemented as the signal processing circuitry in hearing aids and cochlear implants. Further applications include use of the present invention for the enhancement of the quality and intelligibility of sound for personal listening/entertainment devices for normal-hearing listeners (especially in situations where loud sounds are involved, or in noisy situations) or for listeners with hearing loss. Such applications include telephones, televisions, radios, home-entertainment systems, and public announcement systems.

What is claimed is:

1. A method for processing a sound spectrum, comprising the steps of:
low pass filtering said sound spectrum at a predetermined cutoff frequency; and
bandpass filtering said sound spectrum at a plurality of base frequencies above said predetermined cutoff frequency.

2. The method of claim 1, wherein said base frequencies are sufficiently separated from each other to create bands of rejected frequencies alternating with bands of allowed frequencies.

3. The method of claim 2, wherein said predetermined cutoff frequency is 1500 Hz.

4. The method of claim 3, wherein said low pass filters and said bank of narrowband filters comprise linear filters.

5. A system for processing a sound spectrum, comprising:
a low pass filter having a cutoff frequency; and
a bank of narrowband filters having base frequencies above said cutoff frequency.

6. The system of claim 5, wherein said center frequencies are selected to create alternating bands of rejected frequencies and allowed frequencies above said cut-off frequency.

7. The system of claim 6, wherein said predetermined cutoff frequency is 1500 Hz.

8. The system of claim 7, wherein said low pass filter and said bank of narrowband filters are linear filter.

9. A system for processing a sound spectrum, comprising:
means for filtering said sound spectrum to allow low frequencies to pass; and
means for filtering said sound spectrum to allow bands of higher frequencies to pass.

10. The system of claim 9, wherein said means for filtering said sound spectrum to allow low frequencies to pass allow frequencies below about 1500 Hz to pass.

11. The system of claim 10, wherein said bands of higher frequencies are interspersed with bands of frequencies that are rejected.
